(19) United States
(12) Patent Application Publication
(10) Pub. No.: US 2014/0064678 A1
(43) Pub. Date: Mar. 6, 2014

(54) SURFACE TREATMENT FOR TPU JACKETS

(71) Applicants: Joseph Cignarale, Greer, SC (US); Marvin Blanton, Campobello, SC (US); Michael Turenne, Simpsonville, SC (US)

(72) Inventors: Joseph Cignarale, Greer, SC (US); Marvin Blanton, Campobello, SC (US); Michael Turenne, Simpsonville, SC (US)

(73) Assignee: AFL TELECOMMUNICATIONS LLC, Duncan, SC (US)

(21) Appl. No.: 14/114,627

(22) PCT Filed: Jul. 13, 2012
(86) PCT No.: PCT/US2012/046671

§ 371 Date: Oct. 29, 2013

Related U.S. Application Data
(60) Provisional application No. 61/507,290, filed on Jul. 13, 2011.

(51) Int. Cl. G02B 6/44

(52) U.S. Cl. CPC G02B 6/443; G02B 6/4486
USPC 385/100; 427/372.2; 427/163.2; 428/394

(57) ABSTRACT

Exemplary implementations of the present invention address at least the above problems and/or disadvantages and other disadvantages not described above. Also, the present invention is not required to overcome the disadvantages described above, and an exemplary implementation of the present invention may not overcome any of the problems listed above. A first embodiment of the invention is a method of manufacturing a thermoplastic polyurethane (TPU)-jacketed cable including: producing a cable with a TPU jacket; applying an aqueous solution to the TPU jacket; and providing an air flow over the TPU jacket so that a film forms on the TPU jacket; wherein the aqueous solution is a solution comprising at least one of stearate, glycerin soap and sodium salt and wherein the concentration of the solution is approximately two to six percent. A second embodiment of the invention is a thermoplastic polyurethane (TPU) jacketed cable including a cable with a TPU jacket; and an aqueous solution film on the TPU jacket; wherein the film includes at least one of stearate, glycerin soap and sodium salt.

### CROSS-REFERENCE TO RELATED APPLICATIONS

This application is based upon and claims the benefit of priority from U.S. Provisional Application No. 61/507,290 filed Jul. 13, 2011 in the United States Patent and Trademark Office, the disclosures of which are incorporated herein in its entirety by reference.

### BACKGROUND

1. Field

The invention is related thermoplastic polyurethane (TPU) cable jackets, and more particularly to TPU cable jackets that are used on fiber optic cables.

2. Related Art

TPU (thermoplastic polyurethane) cable jackets are used on fiber optic cables because they provide the cable with a shiny or glossy finish. However, these cables can become tacky when they are extruded to have a shiny or glossy finish. This is due to the inherent properties of elastomers and the increased surface area of contact for a smooth finish. Some processing parameters can be adjusted to improve the condition slightly. However, when the finished cable is subjected to heat, humidity, and time, the jacket will again become tacky and can stick to itself on the reel as well as to re-spooling equipment. This makes the product hard to handle in subsequent processing or deployment. As TPU jackets are common in cables that are re-deployable, proper handling and spooling is critical to product performance.

Therefore, an object of the invention is provide a method making TPU cable jacket that is easy to handle and does not become tacky during manufacture or use and a TPU cable jacket with these properties.

### SUMMARY

Exemplary implementations of the present invention address at least the above problems and/or disadvantages and other disadvantages not described above. Also, the present invention is not required to overcome the disadvantages described above, and an exemplary implementation of the present invention may not overcome any of the problems listed above.

A first embodiment of the invention is a method of manufacturing a thermoplastic polyurethane (TPU)-jacketed cable including: producing a cable with a TPU jacket; applying an aqueous solution to the TPU jacket; and providing an air flow over the TPU jacket so that a film forms on the TPU jacket; wherein the aqueous solution is a solution comprising at least one of stearate, glycerin soap and sodium salt and wherein the concentration of the solution is approximately two to six percent.

A second embodiment of the invention is a thermoplastic polyurethane (TPU)-jacketed cable including a cable with a TPU jacket; and an aqueous solution film on the TPU jacket; wherein the film includes at least one of stearate, glycerin soap and sodium salt.

### BRIEF DESCRIPTION OF THE DRAWINGS

FIG. 1 shows an embodiment of the invention.

FIG. 2 shows an embodiment of a cable produced by the invention.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Hereinafter, the exemplary embodiments will be described with reference to accompanying drawings. If the components are the same in different drawings, the same item numbers are used to the extent possible for ease of reference.

Methods of manufacturing TPU cable jackets for fiber optic cable are known. This invention improves on the conventional methods of adding a processing step of applying an aqueous solution of a stearate or glycerin soap and/or certain sodium salts to the jacket in order to eliminate the post-extruded cable jacket material from sticking to itself or processing equipment (guides, rollers, sheaves).

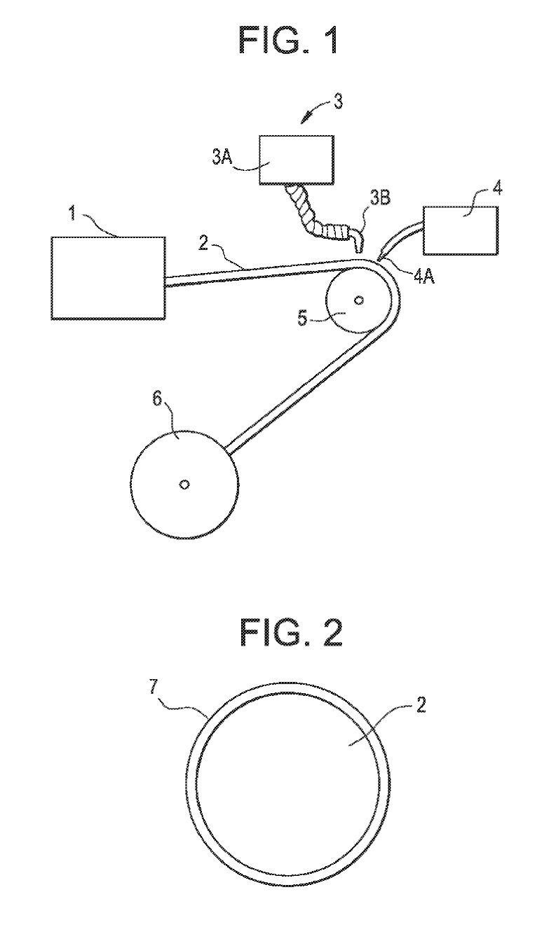

FIG. 1 shows an embodiment of the invention. A TPU fiber optic cable is manufactured by conventional methods on a production line 1. The cable 2 produced by the line 1 then proceeds to an area that includes an aqueous solution supplier 3 and an air blower 4. The aqueous supplier 3 may include a holding tank 3A for the solution and a nozzle 3B for spraying the solution on the cable 2 as the cable moves from the production line 1 to a reel 6, where the cable 2 is spooled. In this particular embodiment the solution is sprayed on the cable 2 as is passes over a roller 5. The flow of the solution should be adjusted so that an even coat can be applied to the cable. If the flow is too slow or foaming occurs, the flow should be adjusted appropriately.

After the solution is applied to the cable 2, the cable passes by an air blower 4. The air blower 4 may have a nozzle 4A that directs an air flow to the cable. In one exemplary embodiment, the air flow is approximately 20 psi. The air blower 4 removes excess solution from the cable. However, a solution film 7 dries and remains on the cable 2. See FIG. 2.

Stearate or glycerin soap and/or sodium salts materials that can be used to create the aqueous solution include, but are not limited to: Sodium stearate (CAS#822-16-2), which has inherent hydrophobic and surfactant properties that are useful in resolving the surface sticking conditions; Glycerin—CAS#56-81-5; Sodium Chloride—CAS#7647-14-5; Sodium Borate—CAS#1330-43-4; Sodium Oleate—CAS#143-19-1; and Sodium Salt of Methyl Tauride—CAS#137-20-2. The solution level for these materials should be approximately 2-6%, with a preferred level of 4%.

In one particular embodiment, the aqueous solution is formed by mixing approximately 8 cups of water (preferably hot) into a container that has approximately 1 cup of Akro Gel powder. The solution is mixed until no lumps of powder or gel are left. The solution is then transferred to the aqueous solution supplier 3.

In addition to reducing adhesion, this invention has the added effect of reducing the coefficient of friction (static and kinetic) of the finished cables.

Other advantages of the invention may include: 1. the material does not stick to itself or processing equipment even after exposure to time, heat and humidity; and 2. the surface friction is greatly reduced as demonstrated by the product being slid over itself (as in the tying of a knot).

Although a few exemplary embodiments of the present invention have been shown and described, it would be appreciated by those skilled in the art that changes may be made in this embodiment without departing from the principles and spirit of the invention, the scope of which is defined in the claims and their equivalents. For example, while the exemplary TPU cable is a fiber optic cable, the invention would apply other types of TPU jacketed cable as well.

What is claimed is:

1. A method of manufacturing a thermoplastic polyurethane (TPU)-jacketed cable comprising:
producing a cable with a TPU jacket;
applying an aqueous solution to said TPU jacket; and
providing an air flow over said TPU jacket so that a film forms on said TPU jacket;
wherein said aqueous solution is a solution comprising at least one of stearate, glycerin soap and sodium salt and wherein the concentration of said solution is approximately two to six percent.

2. The method of claim 1, wherein said cable is a fiber optic cable.

3. The method of claim 1, wherein said concentration is approximately four percent.

4. The method of claim 2, wherein said concentration is approximately four percent.

5. A thermoplastic polyurethane (TPU)-jacketed cable comprising:
a cable with a TPU jacket; and
an aqueous solution film on said TPU jacket;
wherein said film comprising at least one of stearate, glycerin soap and sodium salt.

6. The cable of claim 5, wherein said cable is a fiber optic cable.
